(19) United States
(12) Patent Application Publication
(10) Pub. No.: US 2017/0362006 A1
(43) Pub. Date: Dec. 21, 2017

(54) Manually Openable Flexible Film Package

(71) Applicant: BEMIS COMPANY, INC., Neenah, WI (US)

(72) Inventors: Craig I. McDougal, Appleton, WI (US); Stephen J. Klein, Oshkosh, WI (US); Zachary C. Heenan, Appleton, WI (US)

(21) Appl. No.: 15/524,732

(22) PCT Filed: Nov. 24, 2014
(86) PCT No.: PCT/US14/67010

§ 371 Date: May 5, 2017

(51) Int. Cl. B65D 75/58; B32B 27/30; B32B 1/02; B65D 65/38; B65D 75/00; B65D 75/32; B32B 7/06; B65D 85/76

(52) U.S. Cl. CPC B65D 75/5855; B32B 7/06; B32B 27/306; B65D 85/76; B65D 65/38; B65D 75/002; B65D 75/326; B32B 1/02; B32B 2307/306; B32B 2307/31; B32B 2307/7244; B32B 2307/748; B32B 2439/70; B32B 2307/736

(57) ABSTRACT

The present invention is directed to packages having a thermoformed product receiving cavity for containing the product formed from a first flexible heat shrinkable film and a lidding film covering the thermoformed product receiving cavity formed from a second flexible non-heat shrinkable film. The present invention also includes an opening tab on each of the two flexible films which are aligned with each other such that each of the tabs has a sufficient surface area facing the other tab but not adhered to it to render each tab readily manually graspable. The opening tab of the first flexible heat shrinkable film includes a distal portion which is curled to improve its graspability.

### BACKGROUND OF THE INVENTION

The present invention relates generally to packaging articles and more particularly, to manually openable packages formed from a first flexible heat shrinkable film and a second flexible non-heat shrink film. The present invention also includes an opening tab on each of the two flexible films which are aligned with each other such that each of the opening tabs has a sufficient surface area facing the other tab but not adhered to it to render each tab manually graspable. A distal portion of the opening tab of the first flexible heat shrinkable film is curled to provide a more convenient means of gripping the opening tab which may then be pulled away from the second flexible non-heat shrinkable film to open the package.

Typical flexible thermoplastic packages which provide the desired abuse protection and other desirable features in the finished package are usually designed to have strong heat seals when sealed about a product. These packages after heat sealing are often difficult to open by the consumer or end user. It has been therefore desirable to have a package which provides adequate protection of the product against environmental contaminants, moisture and air, and which includes sufficiently strong heat seals to maintain the integrity of the package through the distribution channels and storage, and at the same time can be easily opened by the consumer without the use of a knife or other cutting implement.

### SUMMARY OF THE INVENTION

The present invention is directed to packages having a thermoformed product receiving cavity for containing the product formed from a first flexible heat shrinkable film and a lidding film covering the thermoformed product receiving cavity formed from a second flexible non-heat shrinkable film. The present invention includes a hermetic seal comprising a perimeter heat seal circumventing the thermoformed product receiving cavity formed by heat sealing a portion of the second flexible non-heat shrinkable film to a portion of the first flexible heat shrinkable film; wherein only one of the films is readily frangible and renders the heat seal manually peelable. The readily frangible film includes either a cohesively peelable layer which separates from itself or an adhesively peelable layer which delaminates from an adjacent layer thereby creating a peelable interface. The present invention also includes an opening tab on each of the two flexible films which are aligned with each other such that each of the tabs has a sufficient surface area facing the other tab but not adhered to it to render each tab readily manually graspable. The opening tabs are conveniently provided by aligning portions of the two films which lie outside the heat seal which joins them to each other and by minimizing or eliminating their exposure to heat and pressure.

An important aspect of the present invention is that the opening tab of the first flexible heat shrinkable film includes a distal portion which is curled to improve its graspability. The curled distal portion of the opening tab of the heat-shrinkable film is formed when the film is heat shrunk around the product. Since one of the tabs has a curled portion while the other is substantially relatively flat, the opening tabs may be easily grasped and pulled away from each other. When the opening tabs are pulled in a direction generally perpendicular to the plane of the perimeter heat seal, the readily frangible film will cleanly peel apart from itself and rupture the hermetic seal thereby opening the package.

In one preferred embodiment, the package has a shape which includes at least one corner and at least one pair of opening tabs positioned at the corner. In another preferred embodiment, the package includes multiple corners and at least one pair of opening tabs positioned at a corner of the package. In yet another preferred embodiment, the package includes multiple corners and more than one pair of opening tabs positioned at the corners of the package. It is also contemplated that the package may have a shape which is substantially curved and does not include any defined corners, in which case, the opening tabs may extend around a portion or the entire length of the perimeter heat seal.

### BRIEF DESCRIPTION OF THE DRAWINGS

Further features and advantages of the present invention will become apparent from the following detailed description, taken in combination with the appended drawings, in which:

FIG. 1 shows a schematic view of one preferred embodiment of a package having a triangular shape according to the present invention.

FIG. 2 shows a schematic view of another preferred embodiment of a package having a rectangular shape according to the present invention,

FIG. 3 shows a schematic view of another preferred embodiment of a package having a circular shape according to the present invention.

FIG. 4 shows a schematic view of one preferred embodiment of a first flexible heat shrinkable film according to the present invention.

FIG. 5 shows a schematic view of one preferred embodiment of a second flexible non-heat shrinkable film according to the present invention.

### DEFINITIONS

“Peelable” and like terminology is used herein to refer to any substrate interface which are engineered to be readily peelable (or delaminate within a particular film layer or between two film layers) without uncontrolled or random tearing or rupturing the packaging materials which may result in premature destruction of the packaging film and package made therefrom. A peelable interface or peelable layer is one that can be manually peeled apart to open a package without resorting to the use of a knife or other implement to tear or rupture the web. In the present invention, the peelable layer or peelable interface must have seal strengths sufficient to prevent failure of the seal during the normal filling process and further normal handling and transport of the packaged article. The seal strengths must also be low enough to permit manual opening of the seal. Preferably, parameters such as choice of materials and lamination conditions may be used to adjust the seal strength to the desired level for the particular package web and packaging application. A peelable layer or peelable interface according to the present invention has an initial seal strength set to a maximum value of 2,500 gram-force/inch and a propagation seal strength (i.e., tearing force) set to a range from between 60 and 2,500 gram-force/inch. In contrast, a non-peelable layer or non-peelable interface is not adapted to peel apart or delaminate in a controlled manner as described above. Non-peelable layers or non-peelable interfaces have initial seal strengths of at least 2,000 gram-force/inch, typically at least 2,500 gram-force/inch.

“Heat Shrinkage” values are obtained by measuring unrestrained shrink of a 10 cm² sample immersed in water at 90° C. (or the indicated temperature if different) for two to ten seconds. Four test specimens are cut from a given sample of the film to be tested. Specimens are cut into squares of 10 cm length in the machine direction (M.D.) by 10 cm. length in the transverse (T.D.). Each specimen is completely immersed for 2-10 seconds in a 90° C. (or the indicated temperature if different) water bath. The specimen is then removed from the bath and the distance between the ends of the shrunken specimen is measured for both the M.D. and T.D. directions. The difference in the measured distance for the shrunken specimen and each original 10 cm side is multiplied by ten to obtain percent shrinkage in each direction. The shrinkage of 4 specimens is averaged and the average M.D. and T.D. shrinkage values reported. It should be noted that heat shrinkable films referred to herein are uniaxially or biaxially oriented film. Preferred heat shrinkable films suitable for the present invention have a Heat Shrinkage value of greater than 10% or 20% or 30% or 40% in both machine and transverse directions as measured at 90° C. for 10 minutes. In contrast, preferred non-heat shrinkable films suitable for the present invention have a Heat Shrinkage value of between 0 and 10% in both machine and transverse directions as measured at 90° C. for 10 minutes.

### DETAILED DESCRIPTION OF THE INVENTION

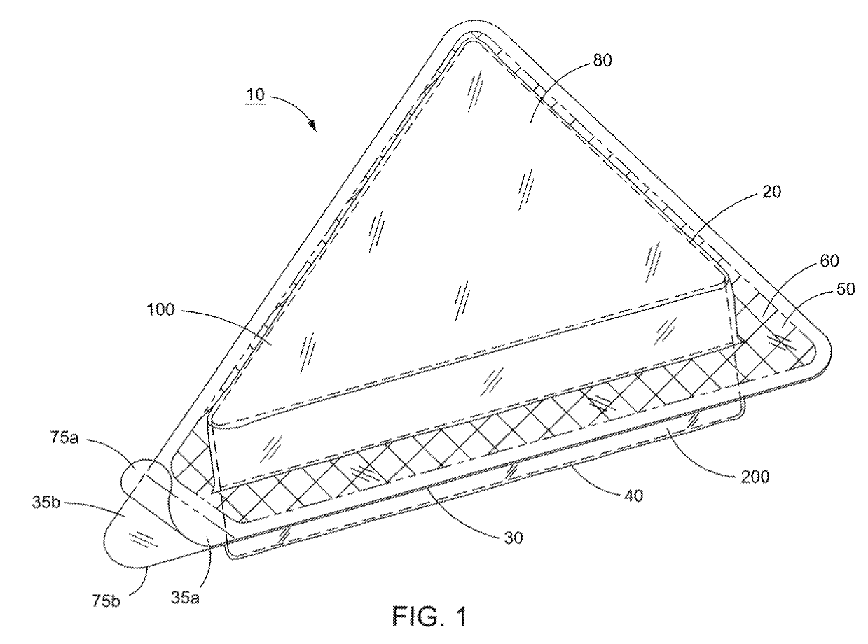

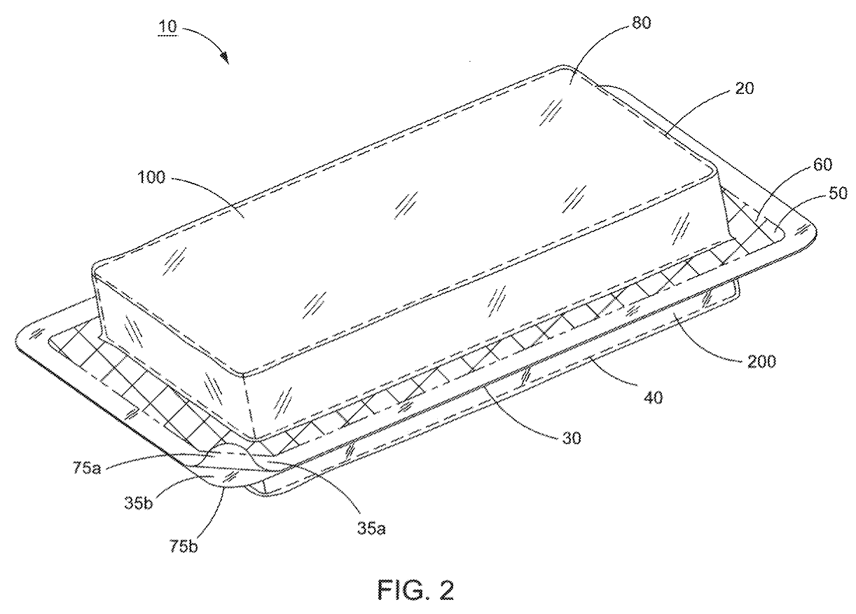

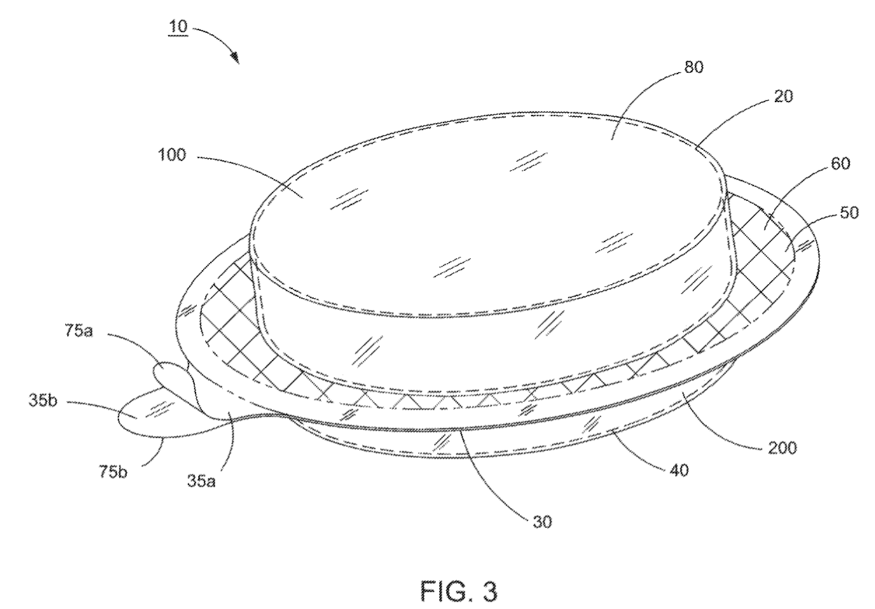

Referring to FIGS. 1-3, a manually openable package 10 is generally indicated in accordance with an embodiment of the present invention. FIG. 1 depicts package 10 has having a substantially triangular shape. Package 10 may be conveniently manufactured by first forming a product receiving cavity 20 from a first flexible heat shrinkable film 100. In a preferred method, film 100 may be placed over a pre-formed mold (not shown) equipped with a gasket (not shown) to help maintain a vacuum that is used to drawn the film into the interior of the mold cavity to shape film 100 into a product receiving cavity. It should be noted that a portion of film 100 extends substantially perpendicular to the cavity which becomes a projected flange 30 of the first flexible heat shrinkable film 100. The draw depth of the thermoformed product receiving cavity may be any value as desired depending upon the shape of the product to be packaged. Typical draw depths may vary between 0.635 cm and 10.2 cm (0.25 in and 4.0 in). In a preferred method, the forming operation of cavity 20 is performed at a temperature of between 90° C. and 105° C. for a time period of between 0.5 and 1.5 seconds. In a preferred embodiment, the product receiving cavity 20 has a shape which includes at least one corner. It may be advantageous to provide a cavity 20 having at least one corner with a radius of about 90° or less. Those skilled in the art will recognize that the dimensions of the product will essentially define the dimensions of the product cavity. Thus, the final package of the present invention may have any shape, size and/or depth as desired depending on the product packaged therein. FIGS. 2 and 3 depict package 10 as having a substantially rectangular and circular shape, respectively.

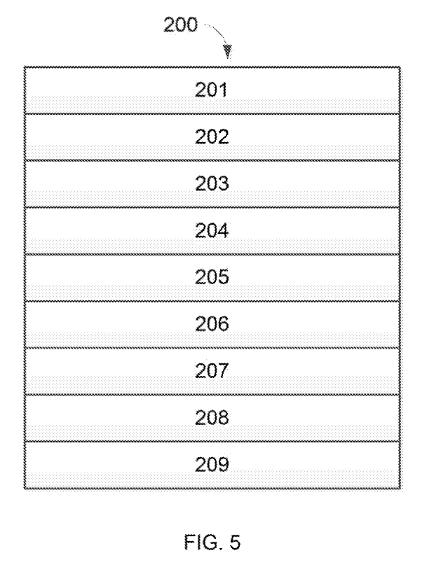

Once the product receiving cavity is formed, a desired product 80 may then be placed within the cavity. Typically, the product is a cheese or meat item, but non-food products can be packaged as well. A non-forming lidding film 40 comprising a second flexible non-heat shrinkable film 200 (see FIG. 5) is placed over the open mouth (not shown) of the formed cavity 20 and a portion of film 200 is sealed to the projected flange 30 of film 100. In a preferred embodiment, the sealing of the films creates a hermetic seal 50 comprising a perimeter heat seal 60 which circumvents the thermoformed product receiving cavity 20. The width of perimeter heat seal 60 may vary depending upon the product packaged, but usually will be at least about 2 mm (about 0.08 in). Typically, the sealing process requires that the sealant layer of both films come into contact with each other under elevated temperature and pressure. In one preferred embodiment, perimeter heat seal 60 is formed at a temperature of 135° C. for 1 second and at a pressure of at least 1 atmosphere. However, those skilled in the art would recognize that sealing times, temperatures and pressures may vary depending upon the materials and thickness of the respective sealant layer of each film.

It is important to note that before the heat sealing operation, a portion 35a of the projected flange 30 of film 100 and a portion 35b of film 200 are aligned with each other outside the perimeter heat seal 60 and have sufficient surface area facing each other or size to be manually graspable. In one preferred embodiment, portions 35a and 35b are isolated from heat and/or pressure during the heat sealing operation and are not sealed together thereby providing an opening tab 75a of film 100 and an opening tab 75b of film 200. In another preferred embodiment, opening tabs 75a and 75b may be formed by treating portion 35a of the projected flange 30a of film 100 and/or portion 35b of film 200 to render one or both portions non-adherent. This may be accomplished by printing a release lacquer or varnish on one or both portions before heat sealing the films together. Alternatively in another embodiment, opening tabs 76a and 75b may be formed by inserting a heat resistant material such as for example Teflon tape between portion 35a of the projected flange 30 of film 100 and portion 35b of film 200 such that the portions do not come into contact with each other during the heat sealing operation. It should also be noted that neither tab 75a nor 75b needs to be heat set prior to the heat sealing operation. In one preferred embodiment, at least one of the opening tabs has at least one dimension of at least about 2 mm (about 0.08 in). In another preferred embodiment, at least one of the opening tabs has at least one dimension of at least about 6 mm (about 0.236 in). In yet another preferred embodiment, at least one of the opening tabs has at least one dimension of at least twice the width of the perimeter heat seal 60.

Once the heat sealing operation is complete, any excess film surrounding the perimeter of the package may be removed thereby individualizing each package. After each package has been separated, they are then exposed to heat to shrink the heat shrinkable film 100 of the cavity 20 about product 80. In one preferred embodiment, the first flexible heat shrinkable film 100 is heat shrunk about the product in a shrink tunnel such as a water bath between a temperature of 80° C. and 90° C. for about 1 to 5 seconds. During this shrink operation, heat shrinkable film 100 forms to the shape of the product. In one preferred embodiment, the first flexible heat shrinkable film 100 shrinks in a uniform manner as to provide a wrinkle-free product receiving cavity 20. Heat shrinkable film 100 will typically exhibit a heat shrinkage value of greater than 10% or 20% or 30% or 40% in both machine and transverse directions as measured at 90° C. for 10 minutes. In one preferred embodiment, film 100 has heat shrinkage value of about 40% in the machine direction and about 44% in the transverse direction at 90° C. In contrast, a non-heat shrinkable film such as film 200 will typically exhibit a heat shrinkage value of less than 30% or 20% or 10% in both machine and transverse directions as measured at 90° C. for 10 minutes.

As the result of the heat shrinkage of first flexible film 100, a curled distal portion 75a on the opening tab 35a is formed. As depicted in FIGS. 1-3, curled distal portion 75a may curve up (away) or down (towards) relative to 75b of film 200 allowing easier grasping the both opening tabs. In one preferred embodiment, to enhance the curling of distal portion 75a, it is particularly advantageous to utilize a first flexible heat shrinkable film 100 having a total thickness of between 50.8 and 254 micron (2 and 10 mil), or between 101.6 and 203 micron (4 and 8 mil), and a second flexible non-heat shrinkable film 200 having a total thickness of between 25.4 and 76.2 micron (1 and 3 mil) or about 50.8 micron (about 2 mil).

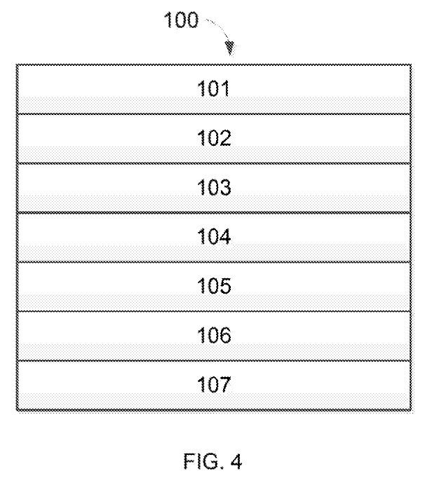

Turning now to FIG. 4, there is shown a cross-sectional view of one preferred embodiment of first flexible heat shrinkable film 100. In this example, first film 100 includes an exterior sealant layer 101 comprising a heat sealing material, a second layer 102 positioned adjacent to the exterior sealant layer 101 which comprises a tie or adhesive material, a third layer 103 positioned adjacent to second layer 102 and comprising a polyamide or blend of polyamide, a fourth layer 104 positioned adjacent to the third layer 103 which comprises an oxygen barrier material, and a fifth layer 105 positioned adjacent to the fourth layer 104 and comprising a polyamide or blend of polyamides, a sixth layer 106 positioned adjacent to fifth layer 105 and comprising a tie or adhesive material, and a seventh exterior layer 107 adjacent to sixth layer 104 and comprising an abuse material. While this example of first flexible heat shrinkable film 100 is depicted as having seven layers, it should be understood that first film 100 may be formed having any number of layers depending upon the desired properties of the final film. Thus first film 100 may be constructed from 1, 2, 3, 4, 5, 6, 7, 8 or more layers.

FIG. 5 depicts a cross-sectional view of one preferred embodiment of second flexible non-heat shrinkable film 200. In this example, second film 200 includes an exterior sealant layer 201 comprising a heat sealing material, a frangible second layer 202 positioned adjacent to the exterior sealant layer 201 which comprises a blend of at least two different polymers, a third layer 203 positioned adjacent to second layer 202 and comprising a tie or adhesive material, a fourth layer 204 positioned adjacent to the third layer 203 which comprises an oxygen barrier material, a fifth layer 205 positioned adjacent to the fourth layer 204 and comprising a tie or adhesive material, a sixth layer 206 positioned adjacent to fifth layer 205 and comprising a polyolefin, a seventh exterior layer 207 adjacent to sixth layer 204 and comprising a polyolefin, an eighth layer 208 positioned adjacent to seventh layer 207 and comprising a tie or adhesive material, and a ninth exterior layer 209 positioned adjacent to eighth layer 208 and comprising an abuse material. While this example of second flexible non-heat shrinkable film 200 is depicted as having nine layers, it should be understood that second film 200 may be formed having any number of layers depending upon the desired properties of the final film.

As used herein, the term “sealant” refers to a layer which is heat sealable to itself or to other materials, i.e., be capable of fusion bonding by conventional heating means which generate sufficient heat on at least one film contact surface for conduction to the contiguous film contact surface and formation of a bond interface therebetween without loss of the film integrity. Advantageously, the bond interface must be sufficiently thermally stable to prevent gas or liquid leakage therethrough. Suitable sealant materials include, but are not limited to polyolefins, such as polyethylenes (PE), including low density polyethylene (LDPE), linear low density polyethylene (LLDPE), very low density polyethylene (VLDPE), and ultra-low density polyethylene (ULDPE); ethylene vinyl acetate copolymers (EVA); ionomers; and blends thereof.

The term “adhesive layer,” or “tie layer” refers to a layer or material placed on one or more layers to promote the adhesion of that layer to another surface. Typically, adhesive layers are positioned between two layers of a multilayer film to maintain the two layers in position relative to each other and prevent undesirable delamination. Unless otherwise indicated, an adhesive layer can have any suitable composition that provides a desired level of adhesion with the one or more surfaces in contact with the adhesive layer material. Optionally, an adhesive layer placed between a first layer and a second layer in a multilayer web may comprise components of both the first layer and the second layer to promote simultaneous adhesion of the adhesive layer to both the first layer and the second layer to opposite sides of the adhesive layer. Tie or adhesive layers may be incorporated into a film or laminate by any of the well-known processes for making multilayer structures such as coextrusion, adhesive lamination and the like. Typical tie materials include, but are not limited to anhydride or carboxylic acid modified polyolefins, particularly, maleic anhydride modified polyolefins such as maleic anhydride modified low density polyethylene, maleic anhydride modified linear low density polyethylene, maleic anhydride modified high density polyethylene, maleic anhydride modified ethylene vinyl acetate copolymers and blends thereof. Tie layer materials may further include a blend of an unmodified polyolefin or unmodified ester copolymer or unmodified ethylene acid copolymer and a modified polyolefin or modified ester copolymer or modified ethylene acid copolymer.

Frangible or peelable film layers are well known in the art and are disclosed in U.S. Pat. No. 4,944,409 (Busche et al.); U.S. Pat. No. 4,875,587 (Lulham et al.); U.S. Pat. No. 3,655,503 (Stanley et al.); U.S. Pat. No. 4,058,632 (Evans et al.); U.S. Pat. No. 4,252,846 (Romesberg et al.); U.S. Pat. No. 4,615,926 (Hsu et al.) U.S. Pat. No. 4,666,778 (Hwo); U.S. Pat. No. 4,784,885 (Carespodi); U.S. Pat. No. 4,882,229 (Hwo); U.S. Pat. No. 6,476,137 (Longo); U.S. Pat. No. 5,997,968 (Dries, et al.); U.S. Pat. No. 4,189,519 (Ticknor); U.S. Pat. No. 5,547,752 (Yanidis), U.S. Pat. No. 5,128,414 (Hwo); U.S. Pat. No. 5,023,121 (Pockat, et al.); U.S. Pat. No. 4,937,139 (Penske, et al.); U.S. Pat. No. 4,916,190 (Hwo); and U.S. Pat. No. 4,550,141 (Hoh), the disclosures of which are incorporated herein in their entirety by reference thereto. In one preferred embodiment, the frangible layer of second film 200 includes a blend of two different polymer resins. Non-limiting examples of such blends combine polyethylene such as low density polyethylene, linear low density polyethylene or ethylene vinyl acetate copolymer as a major component with a polybutylene-1 as a minor component. The major component of these blends is present in an amount of at least 50%, 60%, 70%, 80% or 90% by weight relative to the total weight of the frangible layer. Typically, these frangible layers provide a relatively weak bond to an adjacent layer whereby the interface between these layers delaminates upon application of force perpendicular to the plane of the interface.

Oxygen barrier materials may include, but are not limited to, polyamides, ethylene vinyl alcohol copolymer (EVOH), polyvinylidene chloride (PVdC), metal or metal oxide coated polymer substrates and the like. In one preferred embodiment of the present invention, both first and second films, 100 and 200, include at least one layer comprising an oxygen barrier material. In another preferred embodiment, both first and second films, 100 and 200, include at least two layers each comprising an oxygen barrier material. In yet another preferred embodiment, both first and second films, 100 and 200, include at least three layers each comprising an oxygen barrier material. However, it should be noted that the present invention does not necessarily require that one or both of the first and second films, 100 and 200, include a layer comprising an oxygen barrier material. But, those skilled in the art will recognize that when packaging an oxygen sensitive product which may include many food items, at least one layer of an oxygen barrier material may be required in one or both films of the present invention to provide a barrier against the ingress of oxygen.

Abuse materials may include, but are not limited to, polyolefins such as polyethylenes (PE) and polypropylenes (PP); polyamides; polyamide blends; polyesters including aromatic and aliphatic polyesters, such as polyethylene terephthalates (PET), polyethylene isophthalates, polyethylene naphthalates; oriented polyamides and oriented aromatic polyesters. Typically, abuse materials provide additional moisture and/or chemical barrier protection to a film. Those skilled in the art will recognize that abuse materials also provide a sufficiently smooth surface for the printing of indicia or graphics that appear on most packaged food or non-food products. In one preferred embodiment of the present, the abuse layer of at least one of the first or second films, 100 or 200, includes printed indicia.

### Working Examples of Film Structures

In the following Example 1, the film structure for first flexible heat shrinkable film 100 depicted in FIG. 4 was produced using a blown film co-extrusion apparatuses, and methods which are well known to those skilled in the art. The blown film co-extrusion film apparatus includes a multi-manifold annular die head for film through which the film composition is forced and formed into a tube. The tube is immediately quenched e.g., via cooled water bath, solid surface and/or air, oriented and then formed into a film which is then be axially slit and unfolded to form a flat film. Film 100 of the invention may be uniaxially oriented or biaxially oriented. In one preferred embodiment, film 100 was oriented following the steps of heating the film and drawing it under conditions effective to extend the film by many times its original length and width in the machine/transverse directions, respectively. The drawn film is then cooled while the drawn film is under tension whereby the heat shrinkable film is produced. It should be noted that the physical properties of the film may vary from those of the polymer blend, depending on the film forming techniques used. Those skilled in the art will appreciate that the thickness of individual layers for film 100 may be adjusted based on desired end use performance, resin or copolymer employed, equipment capability and other factors. In at least one preferred embodiment, the first flexible heat shrinkable film 100 has a thickness of at least twice the thickness of the second flexible non-heat shrinkable film 200.

In the following Example 2, the film structure for first flexible non-heat shrinkable film 200 depicted in FIG. 5 was produced by forming a unitary film of layers 201 through 207 using blown film co-extrusion apparatuses, and methods. The unitary film and the remaining layer 208 and 209 were fabricated into a laminate using adhesive lamination apparatus, and method which are also well known to those skilled in the art.

### Example 1

Example 1 is one embodiment of a first flexible heat shrinkable film 100 of the present invention having a layer sequence (in the order as shown below) and layer compositions as described below and as illustrated in FIG. 5. Reported below is the layer composition relative to the total weight of the layer.
Layer 101 (Sealant): 52 wt.-% of a very low density polyethylene (VLDPE)-MXSTEN® CV77526 (Westlake Chemical, Houston, Tex., USA), 43.5 wt-% of a linear low density polyethylene (LLDPE)-ExxonMobil EXACT™ 3139 (ExxonMobil Chemical Company, Houston, Tex., USA)+4.5 wt.-% of processing aids.
Layer 102: 40 wt.-% of a very low density polyethylene (VLDPE)-EXACT™ SLP 9523 (ExxonMobil Chemical Company, Houston, Tex., USA), 30 wt.-% of an anhydride modified linear low density polyethylene-Bynel® CXA 41E710 (E.I. du Pont de Nemours and Company, Inc., Wilmington, Del., USA), 24 wt.-% of a very low density polyethylene (VLDPE)-MXSTEN® CV77526 (Westlake Chemical, Houston, Tex., USA)+6 wt.-% of processing aids.
Layer 103: 85 wt-% of a nylon 6-Ultramid® B36 01 (BASF Polyamides and Intermediates, Freeport, Tex., USA)+15 wt.-% of a nylon 6I/6T-Selar® PA 3426 (E.I. du Pont de Nemours and Company, Inc., Wilmington, Del., USA).
Layer 104: 100 wt.-% of an ethylene vinyl alcohol copolymer (EVOH)-Soarnol™ AT 4403 (Soares L.L.C., Arlington Heights, Ill., USA).
Layer 105: 85 wt.-% of a nylon 6-Ultramid® B36 01 (BASF Polyamides and Intermediates, Freeport, Tex., USA)+15 wt-% of a nylon 6I/6T-Selar® PA 3426 (E.I. du Pont de Nemours and Company, Inc., Wilmington, Del., USA).
Layer 106: 40 wt-% of a very low density polyethylene (VLDPE)-EXACT™ SLP 9523 (ExxonMobil Chemical Company, Houston, Tex., USA), 30 wt.-% of an anhydride modified linear low density polyethylene-Bynel® CXA 41E710 (E.I. du Pont de Nemours and Company, Inc., Wilmington, Del., USA), 24 wt.-% of a very low density polyethylene (VLDPE)-MXSTEN® CV77526 (Westlake Chemical, Houston, Tex., USA)+6 wt.-% of processing aids.
Layer 107: 85 wt.-% of a nylon 6-Ultramid® B36 01 (BASF Polyamides and Intermediates, Freeport, Tex., USA)+15 wt-% of a nylon 6I/6T-Selar® PA 3426 (E.I. du Pont de Nemours and Company, Inc., Wilmington, Del., USA).

Example 2 is one embodiment of a second flexible non-heat shrinkable film 200 of the present invention having a layer sequence (in the order as shown below) and layer compositions as described below and as illustrated in FIG. 6. Reported below is the layer composition relative to the total weight of the layer.
Layer 201 (Sealant): 95 wt.-% of an ethylene vinyl acetate copolymer (EVA)-Petrothene® NA442 (Equistar Chemicals, LP, Houston, Tex., USA)+5 wt.-% of processing aids.
Layer 202 (Frangible): 82 wt.-% of an ethylene vinyl acetate copolymer (EVA)-Petrothene® NA442 (Equistar Chemicals, LP, Houston, Tex., USA)+18 wt.-% of a polybutylene-Polybutene-1 PB 8640M (Equistar Chemicals, LP, Houston, Tex., USA).
Layer 203: 85.9 wt.-% of a linear low density polyethylene (LLDPE)-DOWLEX™ 2045G (Doe Chemical Company, Midland, Mich., USA)+14.1 wt.-% of an anhydride modified linear low density polyethylene-Bynel® CXA 41E710 (E.I. du Pont de Nemours and Company, Inc., Wilmington, Del., USA).
Layer 204: 100 wt.-% of an ethylene vinyl alcohol copolymer (EVOH)-Soarnol™ AT 4403 (Soarers L.L.C., Arlington Heights, Ill., USA).
Layer 205: 85.9 wt.-% of a linear low density polyethylene (LLDPE)-DOWLEX™ 2045G (The Dow Chemical Company, Midland, Mich., USA)+14.1 wt.-% of an anhydride modified linear low density polyethylene-Bynel® CXA 41E710 (E.I. du Pont de Nemours and Company, Inc., Wilmington, Del., USA).
Layer 206: 64.1 wt.-% of an ultra-low density polyethylene (ULDPE)-ATTANE™ NG 4701G (The Dow Chemical Company, Midland, Mich., USA), 34.8 wt.-% of a linear low density polyethylene (LLDPE)-ExxonMobil™ LLDPE 1001.32 (ExxonMobil Chemical Company, Houston, Tex., USA)+1.1 wt.-% of processing aids.
Layer 207: 64.1 wt.-% of an ultra-low density polyethylene (ULDPE)-ATTANE™ NG 4701G (The Dow Chemical Company, Midland, Mich., USA), 34.8 wt.-% of a linear low density polyethylene (LLDPE)-ExxonMobil™LLDPE 1001.32 (ExxonMobil Chemical Company, Houston, Tex., USA)+1.1 wt-% of processing aids.
Layer 208: 100 wt.-% of a lamination adhesive (2-part ethanol based adhesive)-Avadyne® AV5210/CA500-83 (Henkel KGaA, Düsseldorf; DE).
Layer 209: 100 wt.-% of a 48 gauge thick, corona treated biaxially oriented polyethylene terephthalate film (OPET)-SP65 (SKC, Inc., Covington, Ga., USA)

The above description and examples illustrate certain embodiments of the present invention and are not to be interpreted as limiting. Selection of particular embodiments, combinations thereof, modifications, and adaptations of the various embodiments, conditions and parameters normally encountered in the art will be apparent to those skilled in the art and are deemed to be within the spirit and scope of the present invention.

What is claimed:

1. A manually openable package for containing a product comprising:
a thermoformed product receiving cavity for containing the product formed from a first flexible heat shrinkable film;
a lidding film covering the thermoformed product receiving cavity formed from a second flexible non-heat shrinkable film;
a hermetic seal comprising a perimeter heat seal circumventing the thermoformed product receiving cavity formed by heat sealing a portion of the second flexible non-heat shrinkable film to a portion of the first flexible heat shrinkable film; wherein only one of the films is readily frangible and renders the heat seal manually peelable;
an opening tab on each of the films which are aligned with each other; wherein each of the opening tabs has a sufficient surface area facing the other tab but not adhered to it to render the opening tab readily manually graspable;
a curled distal portion on the opening tab of the first flexible heat shrinkable film to assist in grasping of the tab which is formed when the first flexible heat shrinkable film is heat shrunk around the product;
wherein the opening tabs of the films are adapted to pull away from each other such that the readily frangible film cleanly peels apart from itself to rupture the perimeter heat seal and open the package.

2. A package according to claim 1, wherein the package has a shape comprising at least one corner.

3. A package according to claim 2, wherein the opening tab on each of the films is positioned at the at least one corner of the package.

4. A package according to claim 1, wherein the first flexible heat shrinkable film has a total thickness of between 50.8 and 254 micron (2 and 10 mil).

5. A package according to claim 4, wherein the first flexible heat shrinkable film has a total thickness of between 101.6 and 203 micron (4 and 8 mil).

6. A package according to claim 1, wherein the second flexible non-heat shrinkable film has a total thickness of between 25.4 and 76.2 micron (1 and 3 mil).

7. A package according to claim 1, wherein the second flexible non-heat shrinkable film has a total thickness of about 50.8 micron (about 2 ml).

8. A package according to claim 1, wherein the first flexible heat shrinkable film has a heat shrinkage of about 40% in the machine direction and about 44% in the transverse direction at 90° C.

9. A package according to claim 1, wherein the product receiving cavity has a draw depth of between 0.636 cm and 12.7 cm (0.25 in and 4 in).

10. A package according to claim 1, wherein the perimeter heat seal has a width of at least about 2 mm (about 0.08 in).

11. A package according to claim 1, wherein at least one of the opening tabs has at least one dimension of at least about 3 mm (about 0.118 in).

12. A package according to claim 11, wherein at least one of the opening tabs has at least one dimension of at least about 6 mm (about 0.236 in).

13. A package according to claim 1, wherein the product receiving cavity is wrinkle-free.

14. A package according to claim 1, wherein the first flexible heat shrinkable film has an oxygen transmission rate of between 0 and 1 cc/100 in²/24 hours at 23° C., 0% relative humidity and 1 atmosphere.

15. A package according to claim 1, wherein the second flexible non-heat shrinkable film has an oxygen transmission rate of between 0 and 1 cc/100 in²/24 hours at 23° C., 0% relative humidity and 1 atmosphere.

16. A package according to claim 1, wherein the second flexible non-heat shrinkable film includes a frangible layer.

17. A package according to claim 1, wherein the frangible layer is immediately adjacent to a heat sealable layer.

18. A package according to claim 1, wherein the frangible layer comprises a blend of ethylene vinyl acetate copolymer and polybutene-1 copolymer.

19. A package according to claim 1, herein the product is a bulk cheese food item.

20. A package according to claim 1, wherein the product is a meat item.
